(19) United States
(12) Patent Application Publication
(10) Pub. No.: US 2010/0032947 A1
(43) Pub. Date: Feb. 11, 2010

(54) Apparatus for generating power using jet stream wind power

(76) Inventor: JoeBen BEVIRT, Santa Cruz, CA (US)

Correspondence Address: MICHAEL A. GUTH, 2-2905 EAST CLIFF DRIVE, SANTA CRUZ, CA, 95062, US

(21) Appl. No.: 12/381,156

(22) Filed: Mar. 6, 2009

Related U.S. Application Data
(60) Provisional application No. 61/034,425, filed on Mar. 6, 2008.

(51) Int. Cl. F03D 9/00; F03D 7/02

(52) U.S. Cl. 290/44; 290/55

(57) ABSTRACT

A wind energy generator for employment in the jet stream or other wind conditions is described herein. The craft includes an airfoil and at least one wind energy generating device. The craft further includes a variable geometry tail boom unit whose orientation relative to the rest of the craft can be adjusted in accordance with the needs of the user. The craft is tethered to the ground. The wind energy generating devices transferring generated electrical power back to the ground using a conductive transfer line or alternative energy transfer means. The can craft further include an airframe onto which the wind energy generating devices can be mounted the airframe can include an open structured airframe. The invention further describes method of putting an energy generating craft into the air. The method comprises becoming airborne in a vertical configuration, transitioning a tail boom into an orientation parallel to plane of the airfoil and entering a horizontal flight configuration.

### CROSS-REFERENCE TO RELATED APPLICATIONS

This application claims priority to U.S. Provisional Application No. 61/034,425 to Bevirt, filed Mar. 6, 2008.

### TECHNICAL FIELD

The invention described herein relates generally to wind power generation In particular, the invention relates to devices and methods for generating electrical power utilizing the wind energy collected from the jet stream. The invention also comprises a method of enabling a wind energy collection craft to use vertical take of and then transition into horizontal operation during use.

### BACKGROUND

The generation of electricity from conventional ground based devices is just beginning to become commercially viable. However, such ground based electrical generation devices are somewhat hampered by the low power density and extreme variability of natural wind currents (in time and space) at low altitudes. For example, typical average energy density at the ground is less than about 0.5 watts per square meter (W/m²). In contrast jet stream energy densities can average about 10 W/m². Also, the large size of ground based rotor blades and slow rotational velocities of such ground based rotor systems presents difficult engineering problems not yet solved. Additionally, the presence of such large rotating blades presents something of an ecological hazard to flying birds.

Accordingly, there is a need for wind-driven power generation sources that are both feasible using existing technologies and capable of generating power on an economically sustainable scale. The apparatuses and methods disclosed here present embodiments that solve some of the problems associated with existing wind powered electricity generation approaches.

### SUMMARY OF THE INVENTION

In accordance with the principles of the present invention, a wind power generation device is disclosed.

In one embodiment, the invention comprises a craft tetherable to the ground. The craft includes an airfoil and at least one wind energy generating device including but not limited to wind driven rotor generators and turbines. The craft is configured to enable a vertical take off and enables a rotation of the craft so that it is normal to the wind direction. In another related approach the wind energy generating devices are rotated so that the blades are normal to the wind direction. The craft can further include a variable geometry tail boom unit whose orientation relative to the rest of the craft can be adjusted in accordance with the needs of the user. The wind energy generating devices transfer generated electrical power back to the ground using a conductive transfer line. Embodiments of the craft further include an airframe onto which the wind energy generating devices can be mounted. In some embodiments the airframe comprises an open structured airframe providing a stable platform for the wind energy generating devices.

In another embodiment a method of putting an energy generating craft into the air is described. Said method includes becoming airborne in a vertical configuration, optionally transitioning a tail boom into an orientation parallel to plane of the airfoil and entering horizontal flight configuration.

These and other aspects of the present invention are described in greater detail in the detailed description of the drawings set forth hereinbelow.

### BRIEF DESCRIPTION OF THE DRAWINGS

The following detailed description will be more readily understood in conjunction with the accompanying drawings, in which:

FIG. 1 is a simplified perspective view of an embodiment of an open airframe wind power generation craft in accordance with the principles of the invention.

FIGS. 2(a)-2(d) are a set of side views of an embodiment of a power generation craft deploying a variable geometry boom in accordance with the principles of the invention.

FIG. 3 is another embodiment of a power generating aircraft in accordance with the principles of the invention.

FIG. 4 is a flow diagram of an embodiment of vertical flight transition to horizontal flight as employed by the craft of this disclosure.

FIG. 5 is another simplified flow diagram of an embodiment of vertical flight transition to horizontal flight as employed by the craft of this disclosure.

It is to be understood that, in the drawings, like reference numerals designate like structural elements. Also, it is understood that the depictions in the Figures are not necessarily to scale.

### DETAILED DESCRIPTION OF THE DRAWINGS

The present invention has been particularly shown and described with respect to certain embodiments and specific features thereof. The embodiments set forth herein below are to be taken as illustrative rather than limiting. It should be readily apparent to those of ordinary skill in the art that various changes and modifications in form and detail may be made without departing from the spirit and scope of the invention.

The following detailed description describes an embodiment of a wind-energy harvesting device for use at many altitudes, but of particular utility when used to generate electrical power when positioned in the jet stream.

The jet stream includes a family of fast flowing, relatively narrow air currents found in the atmosphere around 10 kilometers above the surface of the Earth. They form at the boundaries of adjacent air masses with significant differences in temperature, such as the polar region and the warmer air to the south. The jet stream is mainly found in the tropopause, at the transition between the troposphere (where temperature decreases with height) and the stratosphere (where temperature increases with height). The wind velocity in the jet stream, although variable, is generally quite high. These speeds can vary with temperature gradient, altitude and locations and can range from 55 kilometers per hour (kph) to over 400 kph. A common mean range for jet stream velocities is in range from about 110 kph to 180 kph. In these jet streams lies a vast untapped potential for wind generated energy. In fact it is estimated that wind energy derived from the jet stream can produce 50 times more energy than terrestrial wind for a given wind flow cross-section.

One approach is to provide an aircraft that can reach the required altitude and supply the aircraft with wind-powered electrical power generation equipment. This energy can then be transmitted elsewhere for use.

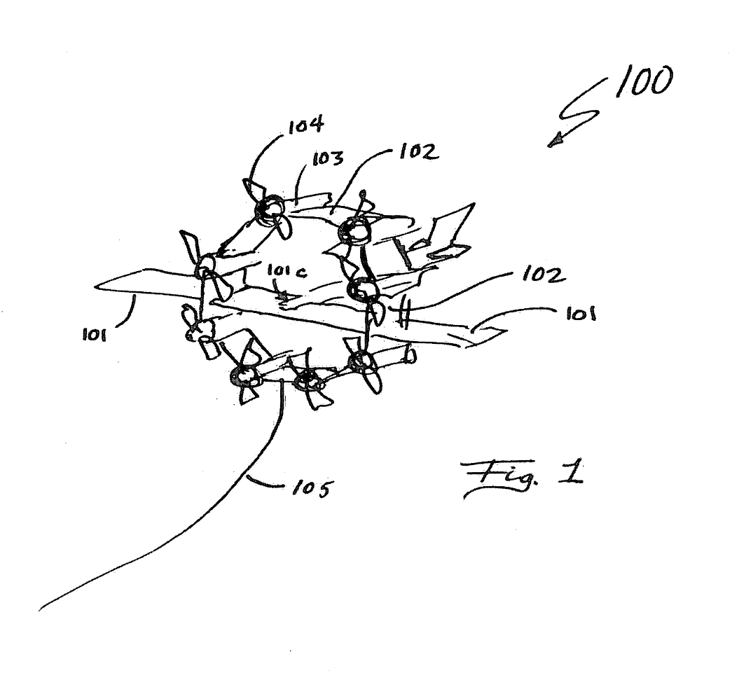

FIG. 1 illustrates one simplified embodiment of such power generation craft 100. The craft 100 includes a main airfoil 101 and an airframe 102 that support a multiplicity of electricity generating wind energy devices 103 (e.g., wind driven rotor generators and wind turbines). The craft is tethered to the ground using a tether 105. Also the craft 100 includes an adjustable variable geometry tail boom 107 which can be used to provide stability to the craft at various points during its “flight”. Various details of this craft are discussed as follows.

The craft includes a main air foil 101 which is used to provide lift for the craft and keep it aloft during its operational lifetime. Airfoils of many different sizes, shapes, and geometries can be employed so long a sufficient lift and stability can be provided. The airfoil can come equipped with the full complement of control surfaces if desired including, but not limited to, aileron, flaps, spoilers, flaperons, elevons, and the like. In the depicted embodiment, the airfoil 101 features a small cutout 101c in the airfoil 101 which can accommodate an optional variable geometry boom as it deploys. Although not necessary to practice the invention, the cutout has certain advantageous uses in some embodiments.

An airframe 102 is attached to the airfoil 101. Although the airframe 102 depicted here is an open airframe that passes an airflow through its inner portions, the inventors contemplate that the airframe 102 can be constructed in many different configurations. As depicted here, the airframe is constructed in a geometric shape (although this need not be so). In some implementations, various portions of the airframe 102 can be configured to generate added lift or be configured as ailerons or rudders or other stabilizing features. Also, the inventors contemplate that appropriate surfaces of the airfoil 101 and airframe 102 could be enhanced with suitably configured lightweight solar panels. As shown here, the depicted airframe takes an octagonal shape. Moreover, in this embodiment, electricity generating wind energy devices 103 are attached to the airframe 102. As depicted here the wind energy devices 103 can be mounted at the vertices of the octagonal airframe 101. It is pointed out that this is merely an example with many other possibilities being readily apparent to those of ordinary skill.

A plurality of wind energy devices 103 are mounted to the airframe 102. The inventors point out that the wind energy devices 103 can instead (or in addition to) be attached to the airfoil 101 if desired. The inventors contemplate that one common wind energy device 103 would be a wind driven rotor generator having a rotor blade driven to power a generator. Many other approaches can be used with one particularly useful embodiment being a wind turbine which can generate substantial energy as a wind flow causes the blades 104 of the turbine to rotate. Such wind turbines are known to those having ordinary skill in the art and will not be elaborated upon at this time. It is also pointed out that many different types of wind turbines could be used if desired. Examples include diffuser augmented wind turbines, Magnus rotors, and other associated technologies. Moreover, the energy generation capacity of such craft can be augmented by any number of added wind generation devices or other energy generation device (e.g., light weight solar panels and the like) known to those having ordinary skill in the art. In some embodiments of the device, the wind energy devices 103 (for example, rotor powered alternators or turbines) are configured so that power can be provided to the devices enabling the blades to turn and generate lift. This lift can be used to move or assist in moving the craft to the desired position and altitude. For example, a ground supplied electricity source (or other source, batteries, solar cells, etc.) is used to power the blades 104 to generate sufficient lift to move (or assist in moving) the craft to its desired location. An advantage to using many wind energy devices is that should one or more of the devices malfunction, the remaining devices offer a reasonable chance of landing the craft without further damage.

Additionally, a tether 105 is attached to the craft to hold it in position so it does not drift away during energy harvesting. The inventors contemplate that the tether can be attached to the craft at many different places. In one particularly attractive (but not limiting) example, the tether is attached at the center of drag for the craft. As can be imagined the tether generally needs to be quite long, on the order of 10-20 kilometers (kms) long. In one example, an 18 km tether can be employed. The tether 105 needs substantial strength to hold the craft 100 in place at the desired position. Materials such as Kevlar™ have the required strength to weight properties. Also, the inventors contemplate other materials can be used. In particular, nano-fiber materials and nano-scale lines may prove to be attractive materials due to their high strength to weight ratios. Additionally, conductive lines are generally employed to transfer power from the craft 100 down to a terrestrial power collection station. Aluminum, copper, or other conductive materials can be used. Aluminum is particular, is an attractive candidate due to its low weight. These conductive lines can run separately down to the collection site or can be affixed with the tether. For example, a coaxial Kevlar and aluminum tether could be used to accomplish energy transfer and secure the craft in place. A conductive core or a conductive sheath could be used with the tether. The inventors further contemplate that energy transfer need not be transferred using a conductive line. It is contemplated that a number of different energy transfer modes could be employed. For example, an energy beam could also be used to accomplish said energy transfer. In one such approach, a microwave generator could be installed on the craft and wind generated energy be used to power a microwave generator which creates a microwave beam that is projected down to a collection site which is suitably configured to receive the beam and convert it into electricity or some other energy.

In some embodiments, the invention includes a configuration suitable for enabling a vertical take off and then enabling a transition to a flight profile where the rotor blades of the energy generation devices are oriented at the desired angle to the wind direction. For example, in one embodiment after vertical take off the blades are then oriented normal to the wind direction. This can be accomplished, for example, by allowing the entire craft to rotate until it reaches the desired flight profile (e.g., normal to wind direction). In another example, the rotating blades of the wind energy generation devices can be independently oriented (independent from the airframe orientation) to the desired angle relative to the wind direction.

In another embodiment (as depicted in FIG. 1), an adjustable variable geometry tail boom 107 is employed in operative combination with the craft 100. The tail boom 107 operates to provide stability to the craft 100. The boom can include vertical and horizontal stabilizers. Also, various configurations can include rudders, trim tabs, stabilators, ruddervators, tailerons, and other stabilizing and control elements. In FIG. 1, the adjustable variable geometry tail boom 107 is set in a configuration optimized for vertical “flight” and will most commonly be deployed in this configuration.

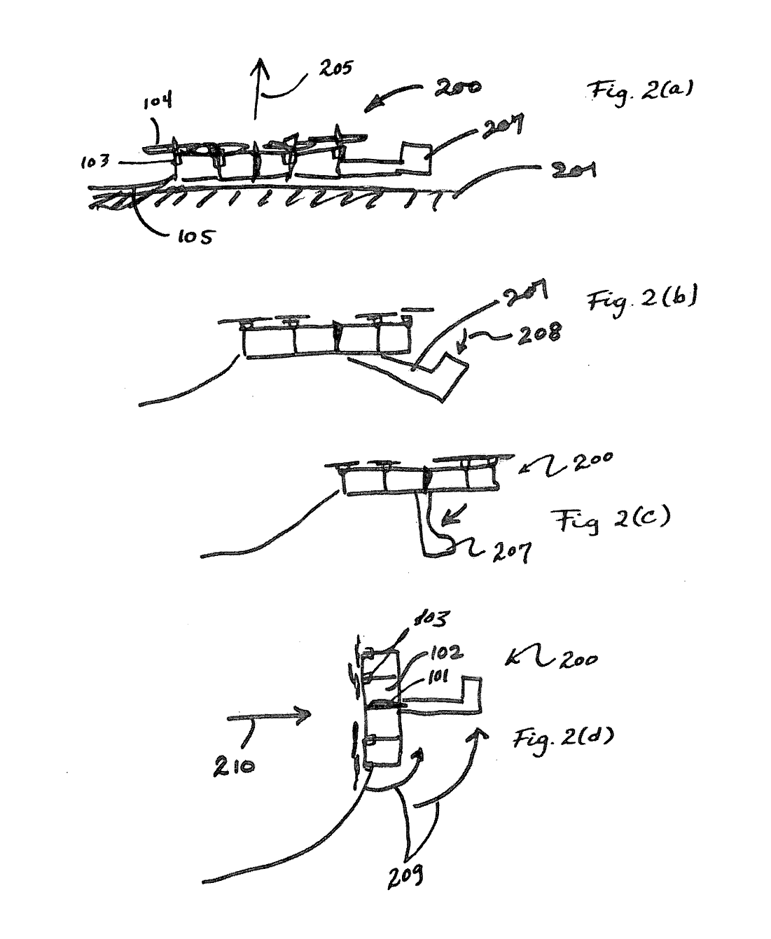

However, reference to FIGS. 2(a)-2(d) shows mode of operation enabling the transition to vertical flight including the use of an optional adjustable variable geometry tail boom. FIG. 2(a) shows the craft 200 on the ground 201 with the tail boom 207 in a folded “up” configuration. As can be seen in this depiction, the wind driven rotor generators (possibly turbines) 103 are oriented with the blades 104 oriented upward. In one embodiment, lift can be applied to the craft 200 by powering the wind driven rotor generators 103. For example, electrical power can be supplied through the tether 105. Alternatively, batteries can be used to power the wind driven rotor generators (if desired these can be ejected after use or maintained to store power). Of course alternative motive sources can be employed. For example, small motors, perhaps powered by fuel cells can be used. The inventors contemplate many ways of powering the blades 104 to attain the needed lift. One advantage of such configuration is that it enables a substantially vertical 205 takeoff profile for the craft. This enables small take areas and minimizes the likelihood of damage to the craft 200. In vertical flight stability can be provided by varying the power to the various blades to enable a substantially level and vertical take off. Additionally, added stability could be provided by counter-rotating blades.

Referring now to FIG. 2(b) the boom 207 is deployed by extending downward. In some embodiments this can occur immediately as the craft takes off. Alternatively, the boom 207 can be deployed by rotating downward 208 once the craft reaches a desired or predetermined altitude. This downward rotation can be effectuated by a small motor and/or with gravitational assistance. Actuation can be provided by many sources. For example, the boom can be deployed by using a signal sent from the ground up the tether 105 to the craft 200. In another example, the boom can be deployed by using a signal sent from the ground via a telecommunications source (radio, microwave, laser, etc.) to the craft 200. Also, a condition sensitive set of instructions can initiate the deployment of the boom. For example, when the craft 200 reaches a predetermined altitude or when it encounters a predetermined wind speed it deploys the boom. FIG. 2(c) depicts the craft 200 when the boom 207 is fully deployed extending vertically downward.

At this point the craft may be moved into vertical flight. FIG. 2(d) shows the craft 200 having a fully extended boom 207. At this point, the craft can use the blades or other aerodynamic means to rotate 209 the craft 200 into a vertical flight configuration. In some embodiments this can occur immediately as soon as the boom is fully deployed. Alternatively, the craft 200 can be rotated forward 209 once the craft reaches a desired or predetermined altitude or once a favorable wind environment has been located. Actuation to rotate forward can be provided by many sources. For example, a signal sent from the ground up the tether 105 to the craft 200 may instruct the craft to rotate into vertical flight configuration. As before a signal can be sent from the ground via a telecommunications source (radio, microwave, laser, etc.) to the craft 200. Also, an onboard microprocessor can initiate vertical flight using a condition sensitive set of, for example, when the craft 200 reaches a predetermined altitude or when it encounters a predetermined wind speed it deploys. Thus, the boom 207 (in fully extended configuration) is rotated upward so that it extends parallel to the plane of the airfoil 101 in a horizontal “flight” configuration.

The configuration depicted in FIG. 2(d) depicts an advantageous orientation for generating power with the wind driven rotor generators. Generally, the craft 200 will be oriented to face the oncoming wind 210 to maximize power generation. Thus, the boom 207 (in fully extended configuration) is rotated away from the wind while remaining generally horizontal and parallel to the plane of the airfoil 101. The applicants point out that some embodiments can be configured so that the wind driven rotor generators 103 can be rotated relative to the airframe. In such embodiments, the wind driven rotor generators can be individually tilted upward some number of degrees so that the rotating blades generate lift as well as generate power when the craft 200 is operational. Also, the entire craft can be angled upwards to can the same effect of generating both power and lift with the blades.

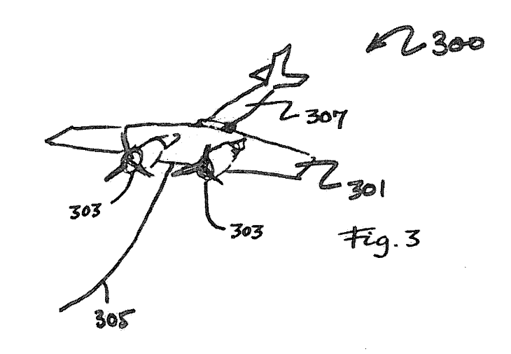

FIG. 3 depicts another simplified embodiment of a power generation craft 300. The craft 300 includes a main airfoil 301 which supports one or more electricity generating wind energy devices 303 (e.g., wind turbines). The craft is tethered to the ground using a tether 305. As with the embodiments described above, the craft 300 includes the ability to transition from a vertical take off mode into a desired flight profile (for example, oriented normal to wind flow). In another embodiment, (depicted here) an adjustable variable geometry tail boom 307 can be used to provide added stability to the craft at various points during its “flight”. Various details of this craft are discussed as follows.

As before, the main air foil 301 provides the lift for the craft and keeps it aloft during its operational lifetime. Airfoils of many different sizes, shapes, and geometries can be employed so long a sufficient lift and stability can be provided. The airfoil can come equipped with the full complement of control surfaces if desired, including but not limited to, aileron, flaps, spoilers, flaperons, elevons, and the like.

Also, the inventors contemplate that appropriate surfaces of the airfoil 301 can be enhanced with suitably configured lightweight solar panels.

The wind energy devices 303 are mounted to the airfoil 301. And as before wind energy devices 303 can include wind turbines. To these can be added Magnus type devices including, but not limited to, Magnus rotors. As before, in some embodiments, the wind energy devices 303 (for example turbines) are configured so that power can be provided to the devices enabling the blades to turn and generate lift. This lift can be used to move or assist in moving the craft to the desired position and altitude.

Additionally, a tether 305 as previously described is attached to the craft to hold it in position so it does not drift away during energy harvesting. Also as before, the inventors further contemplate that energy transfer need not be transferred using a conductive line. It is contemplated that a number of different energy transfer modes could be employed. For example, an energy beam could also be used to accomplish said energy transfer. In one such approach, a microwave generator could be installed on the craft and wind generated energy be used to power a microwave generator which creates a microwave beam that is projected down to a collection site which is suitably configured to receive the beam and convert it into electricity or some other energy.

In the depicted embodiment, an adjustable variable geometry tail boom 307 is employed in operative combination with the craft 300. In this embodiment, the boom 107 is hinged about a rear portion of the airfoil 301. The tail boom 307 operates and is configured as before. In FIG. 3, the adjustable variable geometry tail boom 307 is set in a configuration optimized for vertical “flight” and will most commonly be deployed in this configuration. Moreover, the boom 307 of the depicted craft 300 operates generally as shown in FIGS. 2(a)-2(d).

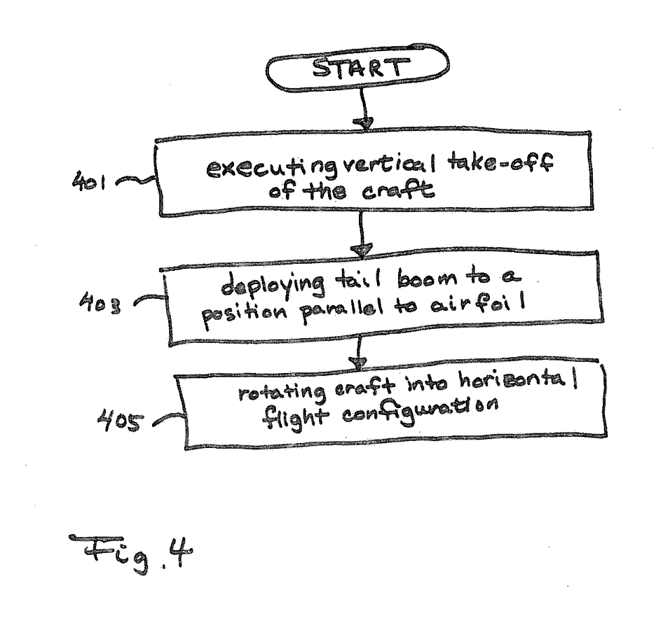

FIG. 4 in association with FIGS. 2(a)-2(d) generally outlines an operating methodology for the craft described herein. The craft 200 (as described in FIG. 2(a)) is resting on the ground 201 in readiness to take off. The craft lies in vertical orientation (i.e., propeller blades 104 oriented so that the direction of lift is vertically upward) with the tether 103 secured to the craft. In operation 401 the blades 104 are rotated with sufficient velocity to enable vertical take off of the craft. The blades are powered by a number of methods described in part above. Such methods include, but are not limited to supplying electrical power to wind driven rotor generators to drive the blades. Once the craft 200 is airborne to a predetermined or desired altitude, the tail boom 207 is deployed (operation 403). The optionally employed tail boom 207 can be rotated until it is deployed. Typically, the boom 207 is deployed when it is generally parallel with the chord line of the airfoil. This exact angle is, of course, set to the angle desired by the operator of the craft depending on the aerodynamic needs of the craft or of the operator. Once the boom 207 is deployed the craft can be switched in to horizontal mode. Commonly, this will be done when the craft 200 reaches the desired position. However, as can be appreciated by those having ordinary skill, such level “flight” aspect can be selected whenever desired. Thus, by rotating the craft to so that the tail is raised relative to the airfoil and the craft rotates forward the horizontal configuration is attained (operation 405). Optional steps can include subsequent power generation, descent, and landing.

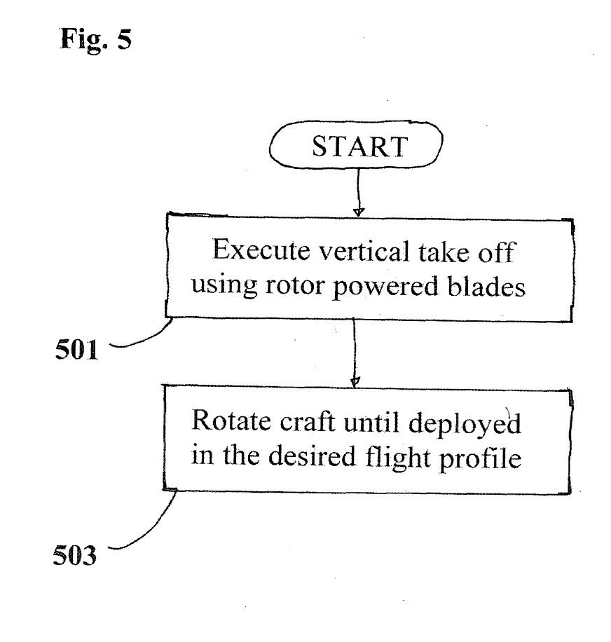

FIG. 5 provides an even more simplified operating methodology for the craft described herein. The craft 200 (without the variable geometry boom) rests on the ground in readiness to take off. The craft lies in vertical orientation (i.e., propeller blades 104 oriented so that the direction of lift is vertically upward) with the tether 103 secured to the craft. In operation 501 the blades 104 are rotated with sufficient velocity to enable vertical take off of the craft. The blades are powered by a number of methods described in part above. Such methods include, but are not limited to supplying electrical power to wind driven rotor generators to drive the blades. Once the craft is airborne to a predetermined or desired altitude, the craft is rotated until it is deployed in the desired flight profile (operation 503). For example, the craft (or independently the wind energy generators) is rotated so that the blades of the wind energy generators are made normal to the direction of air flow. The exact angle is, of course, variable and set to the angle desired by the operator of the craft depending on the aerodynamic needs of the craft or of the operator. Thus, by rotating the craft forward the horizontal configuration is attained. Optional steps can include subsequent power generation, descent, and landing.

The present invention has been particularly shown and described with respect to certain preferred embodiments and specific features thereof. However, it should be noted that the above-described embodiments are intended to describe the principles of the invention, not limit its scope. Therefore, as is readily apparent to those of ordinary skill in the art, various changes and modifications in form and detail may be made without departing from the spirit and scope of the invention as set forth in the appended claims. Other embodiments and variations to the depicted embodiments will be apparent to those skilled in the art and may be made without departing from the spirit and scope of the invention as defined in the following claims. In particular, it is contemplated by the inventors that the aircraft described herein may demonstrate a wide range of airframes and are not limited to the specific open airframe octagonal shape depicted. The inventors also contemplate a variety of wind powered electricity generators beyond wind turbines. Further, reference in the claims to an element in the singular is not intended to mean “one and only one” unless explicitly stated, but rather, “one or more”. Furthermore, the embodiments illustratively disclosed herein can be practiced without any element which is not specifically disclosed herein.

What is claimed is:

1. An aerodynamic platform arranged to support wind-powered electrical generators suitable for harvesting wind energy and converting it to electricity, the platform comprising:
an airfoil;
a support framework including a variable geometry tail boom that can be tilted with respect to the airfoil;
a plurality of wind turbines suitable for generating electricity and suitable for being powered to generate lift sufficient to enable the platform to take flight using the powered turbines, the turbines mounted to the aerodynamic platform.

2. The platform of claim 1 wherein the plurality of wind turbines are electrically powered to generate lift.

3. The platform of claim 1 wherein the support framework includes at least one lift generating member.

4. The platform of claim 1 configured such that when the platform rests on the ground:
the tail boom extends substantially parallel to the ground; and
the airfoil is arranged such that a leading edge of the airfoil points upward and the airfoil chord is at or near normal to the ground.

5. The platform of claim 4 configured such that when the platform rests on the ground the turbine blades are arranged at or near parallel to the ground.

6. The platform of claim 1 wherein the plurality of wind turbines comprise shrouded wind turbines.

7. The platform of claim 1 wherein the platform includes control surfaces capable of maneuvering the platform.

8. The platform of claim 1 wherein the variable geometry tail boom includes an empennage and wherein the empennage includes at least some of the control surfaces.

9. The platform of claim 1 wherein the platform comprises a portion of a power generation and management system having;
a tether system that anchors the platform to the ground while the platform is airborne; and
a power transmission system that that transmits energy from the turbines to a power station.

10. The power generation and management system of claim 9 wherein the power generation and management system includes a control system that monitors and adjusts the performance of at least one of the platform, the turbines, the tether system, and the power transmission system.

11. The power generation and management system of claim 9 wherein the power station includes energy storage elements and a power distribution network.

12. The power generation and management system of claim 11 wherein the energy storage elements include at least one of a capacitive element, a battery element, and a superconducting magnetic energy storage system: and
the power distribution network includes a power grid.

13. The power generation and management system of claim 9 wherein the power generation and management system includes a control system that controls the performance of at least one of the platform, the turbines, the tether system, and the power transmission system.

14. The power generation and management system of claim 13 further including a remote sensing system capable of measuring weather and wind conditions and wherein the control system receives such information as inputs and accordingly adjusts the performance of at least one of the platform, the turbines, the tether system, and the power transmission system.

15. A method of enabling an aerodynamic platform that supports wind-powered electrical generators to take off from a surface, the method comprising:
providing a tethered aerodynamic platform that mounts a plurality of wind turbines and includes an airfoil arranged with a variable geometry tail boom, the platform being positioned on a surface such that such that the airfoil is oriented with its leading edge pointing upward and the blades of the turbines oriented to provide upward lift and such that the variable geometry tail boom extends generally parallel to the surface;
providing power to the turbines sufficient to cause the turbine blades to rotate and generate lift causing the platform to rise from the surface;
changing the angle between the surface and the tail boom as the platform rises and a portion of the tail boom remains in contact with the surface;
securing the boom in position once the variable geometry tail boom clears the ground, with the boom secured generally parallel with a chord of the airfoil;
using the powered turbines to enable the platform to climb to a desired altitude; and
maneuvering the platform such that the secured tail boom pitches upward to enable the platform to attain a desired flight attitude.

16. The method of claim 15 further including flying the platform to a desired position.

17. The method of claim 16 further including:
terminating the power supply to the turbines;
rotating the turbine blades under wind power to generate electricity; and
transmitting the generated electricity to the power station using the power transmission system.

18. The method of claim 16 wherein flying the platform to a desired position comprises flying the platform to a position relative to a wind that is optimized to produce the greatest amount of electricity.

19. The method of claim 16 wherein flying the platform to a desired position comprises flying the platform to at least one of:
a position that enables a desired length of tether to be used to anchor the platform in the position;
a position that enables the tether to attain a desired angle with the ground and the platform;
a position that places the platform at a desired altitude; and
a position that enables a desired tension to be exerted on the tether.

20. The method of claim 16 wherein flying the platform to a desired position comprises flying the platform to a position in the jet stream.
